(19) United States
(12) Patent Application Publication
(10) Pub. No.: US 2016/0344257 A1
(43) Pub. Date: Nov. 24, 2016

(54) ELECTRIC POWER GENERATOR DEVICE

(71) Applicants: SHENG-CHUANG CHANG, Taipei City (TW); FENG-CHEN CHANG, Keelung City (TW)

(72) Inventors: SHENG-CHUANG CHANG, Taipei City (TW); FENG-CHEN CHANG, Keelung City (TW)

(21) Appl. No.: 15/224,600

(22) Filed: Jul. 31, 2016

Related U.S. Application Data
(63) Continuation-in-part of application No. 13/433,808, filed on Mar. 29, 2012, now abandoned.

(51) Int. Cl. H02K 7/116; H02K 7/18

(52) U.S. Cl. CPC H02K 7/116; H02K 7/1807; H02K 53/00

(57) ABSTRACT

An electric power generator device includes a dynamic force source device for generating a dynamic force, a generator further comprising a rotor with an axle for generating electric power with a low rotor speed. and a moment transmission mechanism at least having a first rotating component and a second rotating component; wherein the first rotating component links the second rotating component, is driven by the dynamic force source, and has a contact with the second rotating component being applied by the dynamic force; the second rotating component has a radius being longest in all the rotating components and a center joining the axle; the radius measured from the contact to the center is defined as a moment arm; the moment arm allows the second rotating component to impose a moment on the rotor with the axle so as to perform rotary motion of the rotor and electric power generation of the generator.

### CROSS-REFERENCE TO RELATED APPLICATIONS

This application is a continuation-in-part of application Ser. No. 13/433,808 filed on Mar. 29, 2012, the disclosure of which is incorporated herein by reference.

### FIELD OF THE INVENTION

The present invention relates to generator devices, and more particularly, to an electric power generator device for enabling a generator to generate electric power efficiently with a low rotational speed.

### BACKGROUND OF THE INVENTION

US20110006533A1 (corresponding to U.S. Pat. No. 8,678,744 B2), entitled “Hydro Torque Electric Generator”, discloses a hydro torque electric generator for producing electricity from flowing water. The devise has a drive shaft with paddles protruding from the drive shaft into the water current flow causing the shaft to rotate. This rotating motion of the shaft is then transferred to a flywheel shaft such that a large heavy flywheel at the inner end of the flywheel shaft can be turned. The flywheel then turns a power take off shaft connected to an electric generator producing electricity. This unique system uses three parallel shafts with connecting interlocking gears and disconnecting points on each shaft consisting of clutches and a transmission. To stored torque generated from the drive shaft a large heavy flywheel is used, which amplifies the rotational velocity. Once placed in flowing water, the devise generates electricity with a unique motion transfer system converting the linear motion of the flowing water to rotational motion.

U.S. Pat. No. 7,750,522B2, entitled “SLOW-SPEED DIRECT-DRIVE GENERATOR” , and U.S. Pat. No. 6,664,692B1, entitled “ELECTRICAL MACHINE”, disclose efficient power generation with a low rotational speed specifically.

### SUMMARY OF THE INVENTION

It is a primary objective of the present invention to provide an electric power generator device for enabling a generator to generate electric power efficiently.

In order to achieve the above and other objectives, the present invention provides an electric power generator device, comprising: a dynamic force source device for generating a dynamic force; a generator further comprising a rotor with an axle for generating electric power with a low rotational speed; a moment transmission mechanism at least having a first rotating component and a second rotating component; wherein the first rotating component links the second rotating component, is driven by the dynamic force source, and has a contact with the second rotating component being applied by the dynamic force; the second rotating component has a radius being longest in all the rotating components and a center joining the axle; the radius measured from the contact to the center is defined as a moment arm; the moment arm allows the second rotating component to impose a moment on the rotor with the axle so as to perform rotary motion of the rotor and electric power generation of the generator.

### BRIEF DESCRIPTION OF THE DRAWINGS

The structure, features, and advantages of the present invention will be described hereunder with preferred embodiments and illustrated with accompanying drawings, in which:

FIG. 1 is a structural block diagram of an electric power generator device of the present invention;

FIG. 2 is a schematic view of the illustration of the working principle of an amplifier for a force, using an example of implementation of a hydraulic system according to the present invention;

FIG. 3 is a structural schematic view of a moment transmission mechanism of the electric power generator device according to an embodiment of the present invention:

FIG. 4 is a structural schematic view of the moment transmission mechanism of the electric power generator device according to another embodiment of the present invention;

FIG. 5 is a schematic view of the electric power generator device according to a variant embodiment of the present invention: and

FIG. 6 is a schematic view of an example of application of the electric power generator device of the present invention to a vehicle.

### DETAILED DESCRIPTION OF THE INVENTION

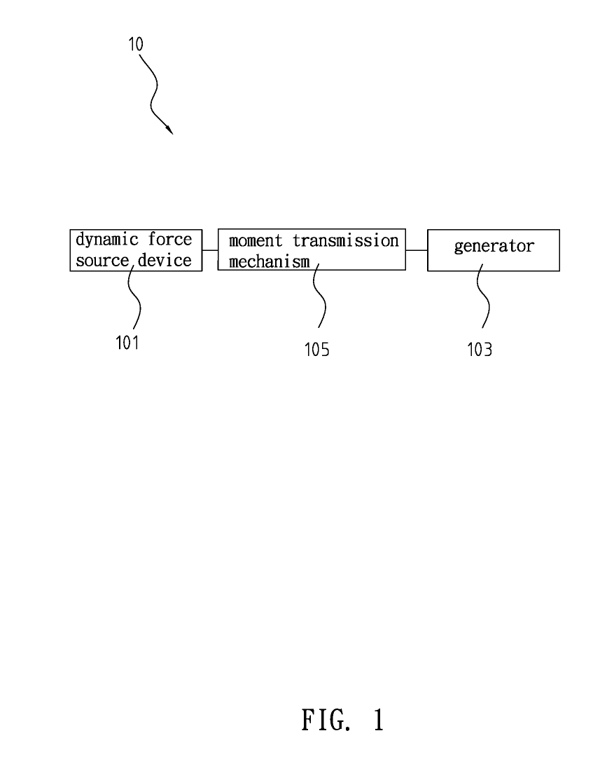

Referring to FIG. 1, an electric power generator device 10 of the present invention comprises a dynamic force source device 101, a generator 103, and a moment transmission mechanism 105 as described underneath.

An important feature of the electric power generator device 10 of the present invention lies in making good use of moment-related physical principles to allow the dynamic force source device 101 to drive the rotation of a rotor 103a of the generator 103 effectively such that the generator 103 can generate electric power under the condition of low rotor speed.

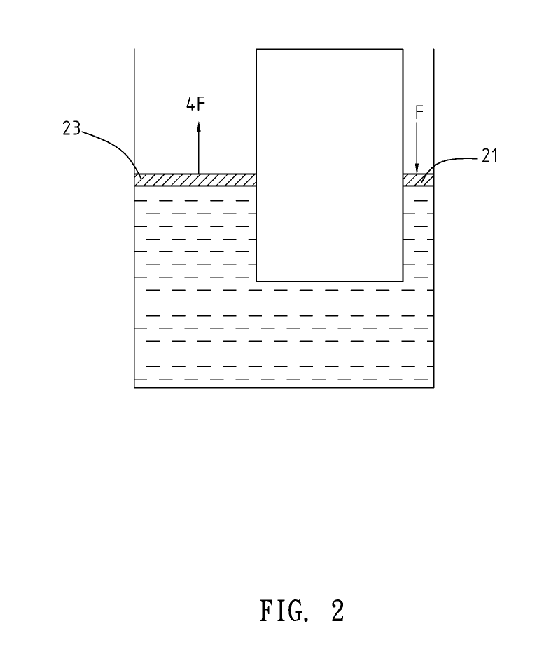

The electric power generator device 10 of the present invention can generate electric power efficiently, because the moment transmission mechanism 105 of the present invention functions as an amplifier for a force. An explanation of this phenomenon starts herein with Pascal's principle. Under Pascal's principle, a change in the pressure of a specific portion of a stationary fluid in a hermetically sealed container is transferred to the container wall that holds every portion of the fluid. Referring to FIG. 2 which depicts a hydraulic system, the exertion of a pressure F upon a piston 21 is accompanied by the generation of another pressure exerted upon another piston 23, wherein, for example, the cross-sectional area of the piston 23 is four times that of the piston 21, and thus the piston 23 is subjected to an amplified pressure 4F which is four times that of the pressure F exerted upon a piston 21. Hence, the hydraulic system of FIG. 2 functions as an amplifier for a force. Although the present invention differs from the hydraulic system of FIG. 2 in terms of physical principles, they have a purpose in common, that is, implementation of an amplifier for a force.

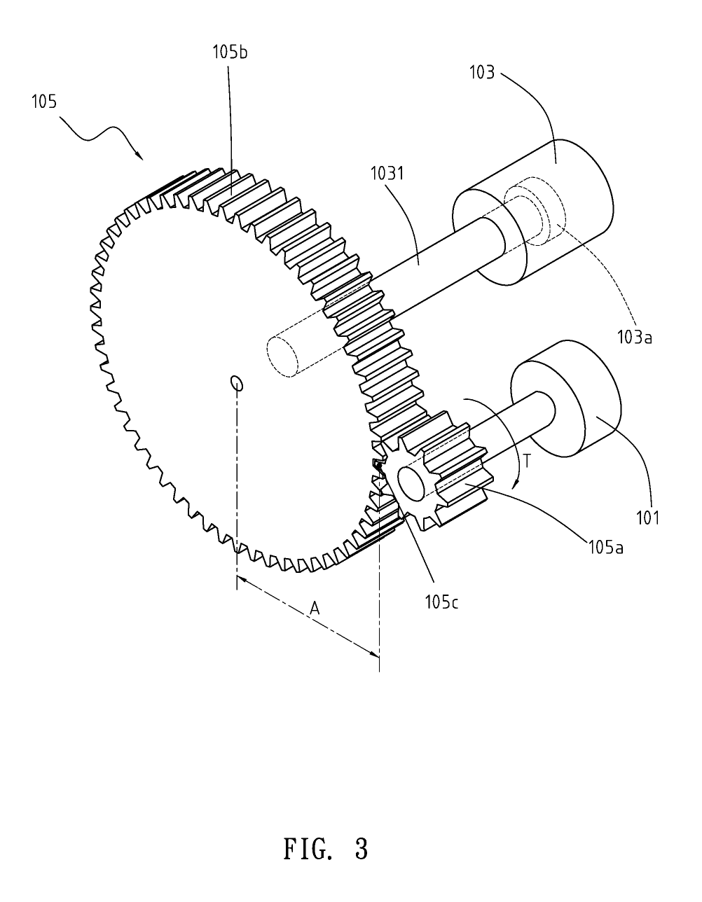

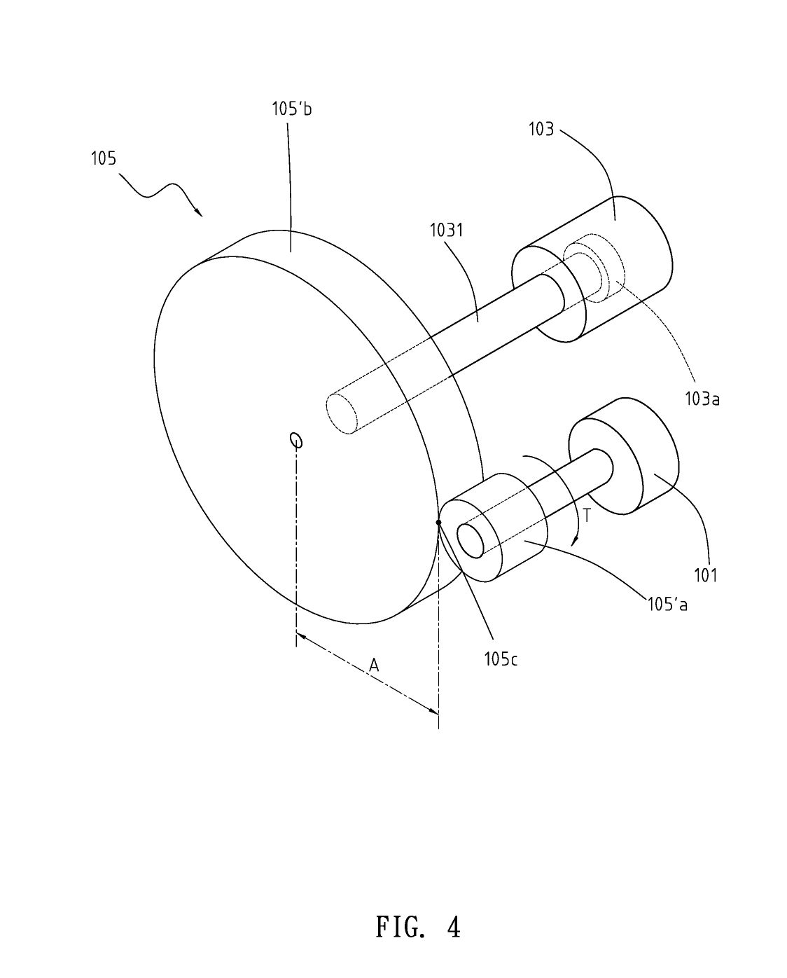

Referring to FIG. 1 again, the purpose of the dynamic force source device 101 is to generate a dynamic force, and the dynamic force thus generated is transmitted by the moment transmission mechanism 105 to drive the rotary motion of the rotor 103a of the generator 103 (see FIGS. 3 and 4). For example, in a specific embodiment, the dynamic force source device 101 is a conventional internal combustion engine, a conventional motor, or a conventional turbine. The conventional internal combustion engine (such as a vehicular engine) undergoes vaporization, ignition, and explosion of gasoline and thus translates a reciprocating motion (or switch-back) motion of a piston into a rotary motion of a crankshaft, such that the rotary motion brings about the dynamic force of the present invention. A conventional motor is supplied with electric power from utility power or a storage battery so as to drive a rotary motion of a rotor of the conventional generator, such that the rotary motion brings about the dynamic force of the present invention. An axle of the conventional turbine is rotated by a passing fluid, and the rotating axle drives the rotor of the conventional generator to undergo a rotary motion, such that the rotary motion of the axle brings about the dynamic force of the present invention.

The purpose of the generator 103 is to generate electric power under a condition of low rotational speed. In a specific embodiment of the present invention, the generator 103 is a conventional generator for use with a wind power generating windmill. In this regard, the conventional generator can be a multipolar synchronous generator disclosed in related prior art and designed to allow power generation to take place at a low rotational speed. In such a situation, a custom-made conventional generator with 50 to 100 poles or even more than 100 poles is required.

The moment transmission mechanism 105 is disposed between the dynamic force source device 101 and the rotor 103a of the generator 103. The moment transmission mechanism 105 produces a large moment to the rotor 103a because of the dynamic force of the dynamic force source device 101. In other words, the dynamic force source device 101 impose a moment effect on the rotor 103a, allowing the moment transmission mechanism 105 to function as an amplifier for a force and thereby driving the rotor 103a effectively to perform the rotary motion.

A specific embodiment of the present invention is put forth below in conjunction with FIGS. 3 and 4 to describe how the moment transmission mechanism 105 imposes a moment on the rotor 103a of the generator 103.

Referring to FIG. 3, there is shown a structural schematic view of the moment transmission mechanism 105 according to an embodiment of the present invention. The moment transmission mechanism 105 comprises at least two gears 105a, 105b. The gears 105a, 105b are meshed together. One of the gears 105a, 105b, for example, the gear 105b, is fixed to the rotor 103a via an axle 1031 of the rotor 103a.

The gear 105a performs a rotary motion under a dynamic force T generated by the dynamic force source device 101. The dynamic force source device 101 shown in FIG. 3 has a shaft to join the gear 105a to impose the dynamic force T on the gear 105a. It is noted that the dynamic force source is conventional such as an internal combustion engine, a motor, or a turbine and no details will be described further. The gear 105b is turned to drive the axle 1031 to rotate due to the rotary motion of the gear 105a. As a result, the rotor 103a rotates with the axle 1031 synchronously to cause the generator 103 to generate electric power. It can be seen in FIG. 3 that a contact 105c, which is a place the gear 105a contacts the gear 105b and impose the dynamic force T to the gear 105h. The contact 105c and the center of the axle 1031 are separated by a distance A which is defined as a moment arm A; the moment arm A is greater than a distance between the contact 105c and the center of the gear 105a. Under the circumferences, the moment transmission mechanism 105 is capable of imposing a moment effect on the rotor 103a by means of the moment arm A.

Referring to FIG. 4, there is shown a structural schematic view of the moment transmission mechanism 105 according to another embodiment of the present invention. The moment transmission mechanism 105 comprises at least two frictional wheels 105′a, 105′b. The frictional wheels 105′a, 105′b are linked together. One of the frictional wheels 105′a, 105′b, for example, the frictional wheel 105a, is fixed to the rotor 103a via a shaft, and the frictional wheel 105′b is fixed to the axle 1031 of the rotor 103a.

The frictional wheel 105′a performs a rotary motion under the dynamic force T generated by the dynamic force source device 101. The dynamic force source device 101 shown in FIG. 4 has a shaft to join the gear 105a to impose the dynamic force T on the gear 105a. It is noted that the dynamic force source 101 can be such as an internal combustion engine, a motor, or a turbine, and it is conventional such that no details will be described further. The frictional wheel 105′a contacts the frictional wheel 1051), and turns the frictional wheel 105′b to drive the axle 1031 to rotate synchronously by means of the rotary motion thereof. As a result, the rotor 103a rotates and causes the generator 103 to generate electric power. It can be seen in FIG. 4 that a contact 105c, which is a place the gear 105a contacts the gear 105b and impose the dynamic force T to the gear 105b. The contact 105c and the center of the axle 1031 are separated by a distance A which is defined as a moment arm A; the moment arm A is greater than a distance between the line of application 105c and the center of the gear 105′a. Under the circumferences, the moment transmission mechanism 105 is capable of imposing a moment effect on the rotor 103a by means of the moment arm A.

In practice, both the gear 105b of FIG. 3 and the frictional wheel 105′b of FIG. 4 have a diameter of 1˜30 m (meters) approximately. The resultant moment effect increases with the diameter of the gear 105b or the frictional wheel 105′b proportionally. Under the circumferences, the rotational speed of the rotor 103a decreases with increase of the diameter of the gear 105b or the frictional wheel 105′b in inverse proportion. Hence, the generator 103 is selected or fabricated for power generation at a low rotational speed.

The aforesaid two specific embodiments are not restrictive of the moment transmission mechanism 105 of the present invention. Any equivalent variant embodiment devised by persons skilled in the art without departing from the spirit embodied in the moment transmission mechanism 105 of the electric power generator device 10 of the present invention, for example, “a variant embodiment in which the moment transmission mechanism 105 comprises a chain, a deflecting bar, or a link for transmitting a dynamic force under which the rotor 103a rotates,” should fall within the scope of the disclosure contained in the present invention.

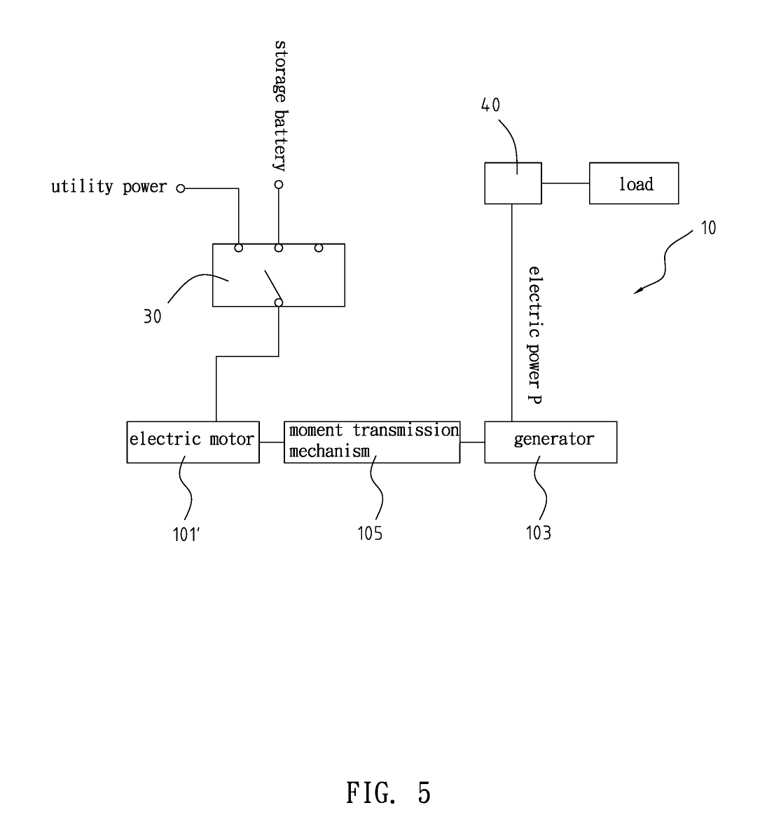

Referring to FIG. 5, there is shown a schematic view of the electric power generator device according to a variant embodiment of the present invention. Additional technical features recited in this variant embodiment include: the dynamic force source device 101 is an electric motor 101′; a portion of electric power generated by the generator 103 is supplied to the electric motor 101′; a power dividing device 40, such as a distributor, provides a distribution electric power P; the portion of the distribution electric power P is returned and supplied to the electric motor 101′; and a switching switch 30 switches between electric power of utility power and electric power of a storage battery or returns the portion of electric power, wherein the purpose of the switching switch 30 is to select electric power to be supplied to the electric motor 101′.

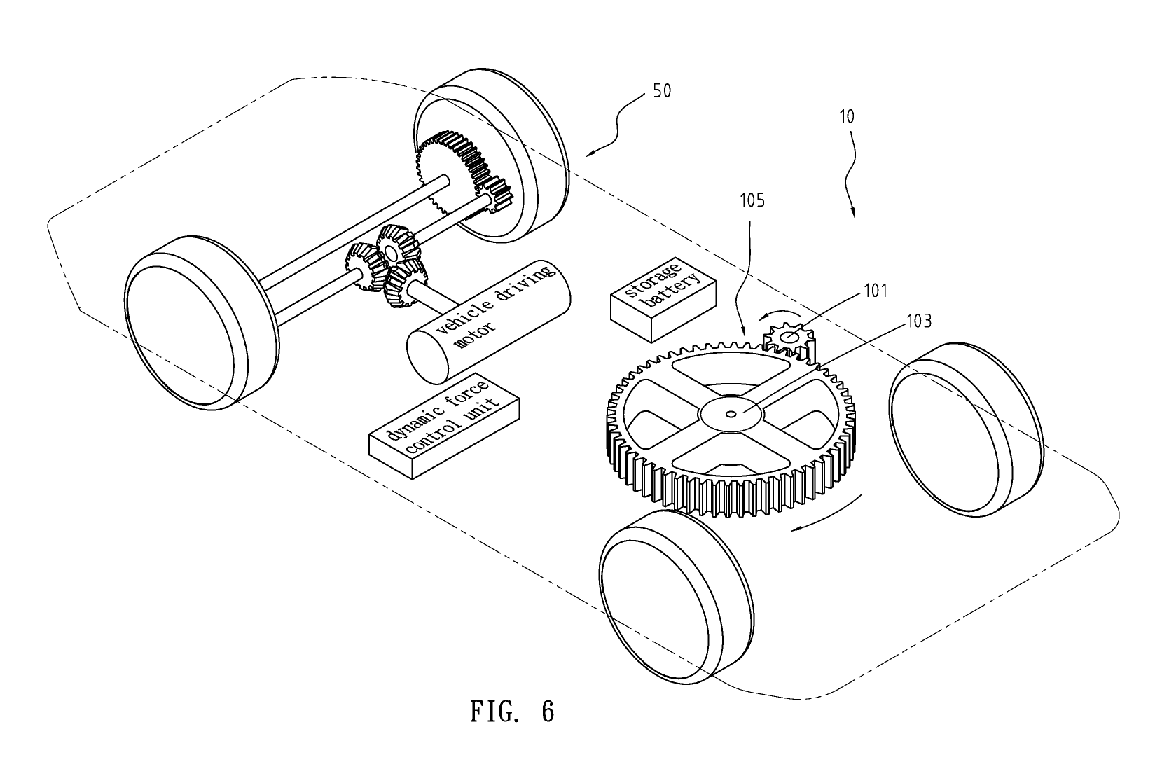

Referring to FIG. 6, there is shown a schematic view of an example of application of the electric power generator device of the present invention to a vehicle. Conventional electric vehicles (such as electric cars or electric buses) or hybrid electric vehicles use rechargeable batteries (such as lithium rechargeable batteries) or fuel cells as their electric power sources and thus arc more environmentally friendly than petroleum-dependent vehicles. The electric power generator device 10 of the present invention is mounted on an electric vehicle 50, such as an electric car. an electric bus, an electric ship, or an electric rail car, to substitute for the aforesaid rechargeable batteries or fuel cells. The electric power generator device 10 mounted on the electric vehicle 50 supplies electric power to a vehicle driving motor and a dynamic force control unit. Furthermore, the electric power generator device 10 supplies a charging current to the storage battery. Also, the storage battery supplies electric power to the vehicle driving motor and the dynamic force control unit while the electric power generator device 10 is idle.

The electric power generator device of the present invention is not only equipped with a moment transmission mechanism that functions as an amplifier for a force but also characterized by integration of a dynamic force and a moment to thereby make good use of a dynamic force generated from a dynamic force source device and enable a generator to generate electric power efficiently-inventive steps disclosed by the present invention.

Hence, the present invention has novelty, non-obviousness, and industrial applicability and thereby meets the requirements of patentability for certain.

The present invention is disclosed above by preferred embodiments. However, persons skilled in the art should understand that the preferred embodiments are illustrative of the present invention only, but should not be interpreted as restrictive of the scope of the present invention. Hence, all equivalent variations and modifications made to the aforesaid embodiments in accordance with the disclosure contained in the claims and specification of the present invention should fall within the scope of the present invention.

What is claimed is:

1. An electric power generator device, comprising:
a dynamic force source device for generating a dynamic force;
a generator further comprising a rotor with an axle for generating electric power with a low rotational speed;
a moment transmission mechanism at least having a first rotating component and a second rotating component;
wherein the first rotating component links the second rotating component, is driven by the dynamic force source, and has a contact with the second rotating component being applied by the dynamic force; the second rotating component has a radius being longest in all the rotating components and a center joining the axle; the radius measured from the contact to the center is defined as a moment arm; the moment arm allows the second rotating component to impose a moment on the rotor with the axle so as to perform rotary motion of the rotor and electric power generation of the generator.

2. The electric power generator device of claim 1, wherein the first rotating component and the second rotating component are gears meshing with each other and the contact is located at where the gears mesh.

3. The electric power generator device of claim 1, wherein the first rotating component and the second rotating component are frictional wheels linking to each other with the contact located at where the frictional wheels contact.
